(19) United States
(12) Patent Application Publication
(10) Pub. No.: US 2022/0414567 A1
(43) Pub. Date: Dec. 29, 2022

(54) COORDINATION OF ELECTRIC VEHICLE CHARGING

(71) Applicant: FORD GLOBAL TECHNOLOGIES, LLC, Dearborn, MI (US)

(72) Inventors: Matthew Atwood WHITAKER, Northville, MI (US); John Houman KOUHSARI, Lansdowne, VA (US)

(73) Assignee: FORD GLOBAL TECHNOLOGIES, LLC, Dearborn, MI (US)

(21) Appl. No.: 17/355,485

(22) Filed: Jun. 23, 2021

(51) Int. Cl. G06Q 10/06; G06Q 10/02; G06Q 30/02; G06F 16/2457; B60L 53/66; G01C 21/34; H04W 4/021

(52) U.S. Cl. CPC G06Q 10/06315; G06Q 10/02; G06Q 30/0201; G06Q 30/0267; G06Q 30/0235; G06F 16/24578; B60L 53/66; G01C 21/3407; H04W 4/021; G06Q 30/0219; G06Q 30/0249; G06Q 30/0273

(57) ABSTRACT

A vehicle scheduling system includes a server that, responsive to receiving a charge request for a vehicle, generate output identifying a list of business entities within a predefined maximum distance of a target charging station that are ranked according to a match with a user profile associated with the vehicle and an incentive offer from at least one of the business entities. The server also, responsive to receiving input selecting one of the business entities, place a reservation with the one of the business entities according to an estimated time of arrival of the vehicle at the one of the business entities.

### TECHNICAL FIELD

The present disclosure relates to a system and method for coordinating electric vehicle charging.

### BACKGROUND

Electric vehicles may take time (e.g. hours) to fully charge the traction battery. Different public charging stations may vary in terms of the capacity to accommodate the charging need of each electric vehicle. Some charging stations may have a large number of chargers to allow multiple vehicles charging at the same time, while others may have a limited number of chargers.

### SUMMARY

A vehicle scheduling system includes a server that, responsive to receiving a charge request for a vehicle, generate output identifying a list of business entities within a predefined maximum distance of a target charging station that are ranked according to a match with a user profile associated with the vehicle and an incentive offer from at least one of the business entities. The server also, responsive to receiving input selecting one of the business entities, place a reservation with the one of the business entities according to an estimated time of arrival of the vehicle at the one of the business entities.

A server includes a processor that responsive to receiving a charging request for a vehicle, identify a plurality of candidate business entities associated with one or more chargers, obtain a business profile associated with each of the business entities and a user profile of a user associated with the vehicle to match with the business profiles, and assign a score to each of the business entities based on the match. The processor also responsive to the user selecting one of the business entities, calculate an estimated time of arrival for the vehicle to arrive at the one of the business entities, and set the one of the business entities as a navigation destination.

A vehicle scheduling system includes a server that, responsive to receiving a charge request for a vehicle from a mobile device associated with the vehicle, the charge request including a desired charging duration, generate output identifying a plurality of target charging stations and a list of business entities associated with the target charging stations that matches the desired charging duration. The server also responsive to receiving input selecting one of the business entities, set one of the charging station associated with the one of the business entities as a vehicle navigation destination.

### BRIEF DESCRIPTION OF THE DRAWINGS

FIG. 1 is a diagram of an electrified vehicle illustrating drivetrain and energy storage components including an electric machine.

FIG. 2 is an example block topology of a vehicle system.

FIG. 3 is an example diagram of the vehicle charging coordinating system.

FIG. 4 is an example diagram of a process for coordinating the vehicle charging.

FIG. 5 is an example flow diagram of the vehicle charging coordinating system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system for managing and coordinating electric vehicle charging.

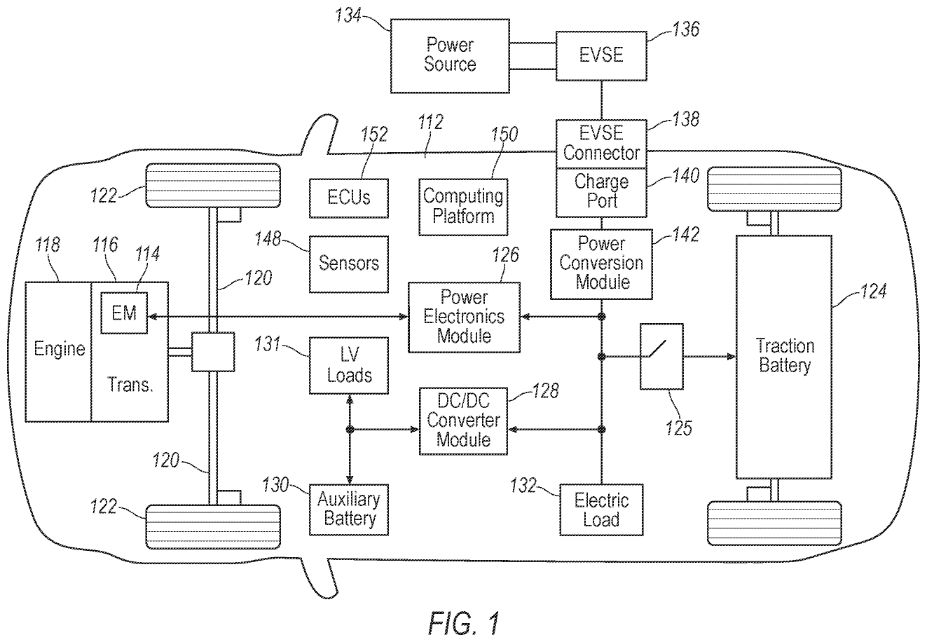

FIG. 1 depicts an electrified vehicle 112 that may be referred to as a plug-in hybrid-electric vehicle (PHEV), a battery electric vehicle (BEV), a mild hybrid-electric vehicle (MHEV), and/or a full hybrid electric vehicle (FHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The hybrid transmission may be switchable between one or more forward gear and a reverse gear to allow the vehicle 112 to switch driving direction. In case that the vehicle 112 is a BEV without the engine 118, the transmission 116 may be a single speed transmission mechanically coupled between the electric machines 114 and the drive shaft 120. The vehicle 112 may switch the driving direction by changing the rotation direction of the electric machine 114. In other words, the vehicle 112 may drive in a forward direction when the electric machine 114 rotates in one direction, and drive in reverse direction when the electric machine 114 rotates in another direction. The electric machines 114 can provide propulsion and braking capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 may store energy that can be used by the electric machines 114. The vehicle battery pack 124 may provide a high voltage direct current (DC) output. The traction battery 124 may be electrically coupled to one or more power electronics modules 126 (such as a traction inverter). One or more contactors 125 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to DC voltage compatible with the traction battery 124.

The vehicle 112 may include a variable-voltage converter (VVC) (not shown) electrically coupled between the traction battery 124 and the power electronics module 126. The VVC may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads. An output of the DC/DC converter module 128 may be electrically coupled to an auxiliary battery 130 (e.g., 12V battery) for charging the auxiliary battery 130. The low-voltage systems having one or more low-voltage loads 131 that may be electrically coupled to the auxiliary battery 130. One or more electrical loads 132 may be coupled to the high-voltage bus/rail. The electrical loads 132 may have an associated controller that operates and controls the electrical loads 146 when appropriate. Examples of electrical loads 132 may be a fan, an electric heating element, and/or an air-conditioning compressor.

The electrified vehicle 112 may be configured to recharge the traction battery 124 from an external power source 134. The external power source 134 may be a connection to an electrical outlet. The external power source 134 may be electrically coupled to a charger or electric vehicle supply equipment (EVSE) 136. The external power source 134 may be an electrical power distribution network or grid as provided by an electric utility company. The EVSE 136 may provide circuitry and controls to regulate and manage the transfer of energy between the power source 134 and the vehicle 112. The external power source 134 may provide DC or AC electric power to the EVSE 136. The EVSE 136 may have a charge connector 138 for plugging into a charge port 140 of the vehicle 112. The charge port 140 may be any type of port configured to transfer power from the EVSE 136 to the vehicle 112. The charge port 140 may be electrically coupled to a charger or on-board power conversion module 142. The power conversion module 142 may condition the power supplied from the EVSE 136 to provide the proper voltage and current levels to the traction battery 124. The power conversion module 142 may interface with the EVSE 136 to coordinate the delivery of power to the vehicle 112. For instance, the power conversion module 142 may selectively adjust the voltage and current level to best match the rate of charge with the need and expected duration of stop and the EVSE 136 (to be discussed in detail later). The EVSE connector 138 may have pins that mate with corresponding recesses of the charge port 140. Alternatively, various components described as being electrically coupled or connected may transfer power using a wireless inductive coupling.

The vehicle 112 may be provided with a computing platform 150 and one or more electronic control units (ECUs) 152 to operate and control various operations of the vehicle 112.

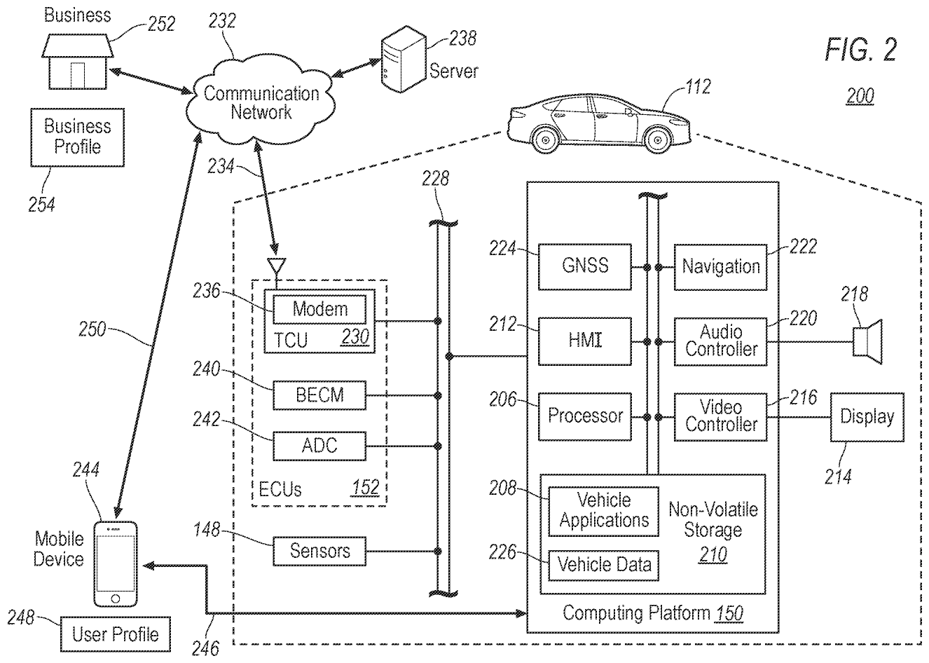

Referring to FIG. 2, an example block topology of a vehicle system 200 of one embodiment of the present disclosure is illustrated. As an example, the system 200 may include the SYNC system manufactured by The Ford Motor Company of Dearborn, Mich. It should be noted that the illustrated system 200 is merely an example, and more, fewer, and/or differently located elements may be used.

As illustrated in FIG. 2, the computing platform 150 may include one or more processors 206 configured to perform instructions, commands, and other routines in support of the processes described herein. For instance, the computing platform 150 may be configured to execute instructions of vehicle applications 208 to provide features such as navigation, remote controls, and wireless communications. Such instructions and other data may be maintained in a non-volatile manner using a variety of types of computer-readable storage medium 210. The computer-readable medium 210 (also referred to as a processor-readable medium or storage) includes any non-transitory medium (e.g., tangible medium) that participates in providing instructions or other data that may be read by the processor 206 of the computing platform 150. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 150 may be provided with various features allowing the vehicle occupants/users to interface with the computing platform 150. For example, the computing platform 150 may receive input from HMI controls 212 configured to provide for occupant interaction with the vehicle 112. As an example, the computing platform 150 may interface with one or more buttons, switches, knobs, or other HMI controls configured to invoke functions on the computing platform 150 (e.g., steering wheel buttons, a push-to-talk button, instrument panel controls, etc.).

The computing platform 150 may also drive or otherwise communicate with one or more displays 214 configured to provide visual output to vehicle occupants by way of a video controller 216. In some cases, the display 214 may be a touch screen further configured to receive user touch input via the video controller 216, while in other cases the display 214 may be a display only, without touch input capabilities. As a few non-limiting examples, the display 214 may be implemented as a liquid crystal display (LCD) screen mounted on the dashboard inside the vehicle 112. The computing platform 150 may also drive or otherwise communicate with one or more speakers 218 configured to provide audio output and input to vehicle occupants by way of an audio controller 220.

The computing platform 150 may also be provided with navigation and route planning features through a navigation controller 222 configured to calculate navigation routes responsive to user input via, for example, the HMI controls 212, and output planned routes and instructions via the speaker 218 and the display 214. Location data that is needed for navigation may be collected from a global navigation satellite system (GNSS) controller 224 configured to communicate with multiple satellites and calculate the location of the vehicle 112. The GNSS controller 224 may be configured to support various current and/or future global or regional location systems such as global positioning system (GPS), Galileo, Beidou, Global Navigation Satellite System (GLONASS) and the like. Map data used for route planning may be stored in the storage 210 as a part of the vehicle data 226. Navigation software may be stored in the storage 210 as one of the vehicle applications 208.

The computing platform 150 may be further configured to communicate with various components of the vehicle 112 via one or more in-vehicle networks 228. The in-vehicle network 228 may include, but is not limited to, one or more of a controller area network (CAN), an Ethernet network, and a media-oriented system transport (MOST), as some examples. Furthermore, the in-vehicle network 228, or portions of the in-vehicle network 228, may be a wireless network accomplished via Bluetooth low-energy (BLE), Wi-Fi, ultra-wideband (UWB), or the like.

The computing platform 150 may be configured to communicate with various electronic control units (ECUs) 152 of the vehicle 112 that are configured to perform various operations. For instance, the ECUs 152 may include a telematics control unit (TCU) 230 configured to control telecommunication between vehicle 112 and a communication network 232 through a wireless connection 234 using a modem 236. The wireless connection 234 may be in the form of various communication networks, for example, a cellular network. Through the communication network 232, the vehicle may access one or more servers 238 configured to perform various operations. The servers 238 may be configured to control and coordinate the battery charging of various vehicles by directing the vehicles to different charging stations (to be discussed in detail below). It is noted that the terms communication network and server are used as general terms in the present disclosure and may include any computing network involving carriers, routers, computers, controllers, circuitry or the like configured to store data and perform data processing functions and facilitate communication between various entities.

The ECUs 152 may further include a battery electric control module (BECM) 240 configured to monitor and control various operations of the traction battery 124. For instance, the BECM 240 may be configured to execute instructions to provide features such as charging, discharging, and other battery management. Such instructions and other data may be maintained in a non-volatile manner using a variety of types of computer-readable storage medium (not shown). The BECM 240 may be further configured to monitor a state of charge (SOC), temperature and health of the traction battery 124 such that parameters such as distance to empty and time to charge may be calculated. The ECUs 152 may further include an autonomous driving controller (ADC) 242 configured to monitor and operate autonomous driving and driving assistant features of the vehicle 112. The ADC 242 may allow the vehicle to autonomously drive to a destination planned by the navigation controller 222. For instance, in response to the navigation controller 222 setting a charging station as a navigation destination, the ADC 242 may operate the vehicle 112 to the charging station in an autonomous manner.

The computing platform 150 may be further configured to communicate with a mobile device 244 via a wireless connection 246 through a wireless transceiver (not show). The mobile device 244 may be configured to perform instructions, commands, and other routines in support of the processes such as navigation, telephone, wireless communication, and multi-media processing. For instance, the mobile device 244 may be associated with a vehicle user and store a user profile 248 in a non-volatile storage medium (not shown). the user profile may include various entries indicative of driving and/or charging preference of the user. The user profile 248 includes various preferences that are not vehicle-based. The vehicle 112 may store a vehicle profile as a part of the vehicle data 226 in the storage 210 of the computing platform 150. The vehicle profile 226 may include various entries indicative of settings, conditions and preferences (e.g. battery, tire pressure, etc) of the vehicle 112 that may affect the driving range. The computing platform 150 and the mobile device 244 may share the vehicle profile 226 and the user profile 248 with each other. In other words, the mobile device 244 may store and process the full or part of vehicle profile 226, and the computing platform 150 of the vehicle 112 may store and process the full or part of user profile 248. The mobile device 244 may be configured to communicate with the server 238 via the communication network 232 through a wireless connection 250. Each of the vehicle 112 and the mobile device may individually or collectively communicate the respective vehicle profile 226 and the user profile 248 to the server 238 via the communication network 232.

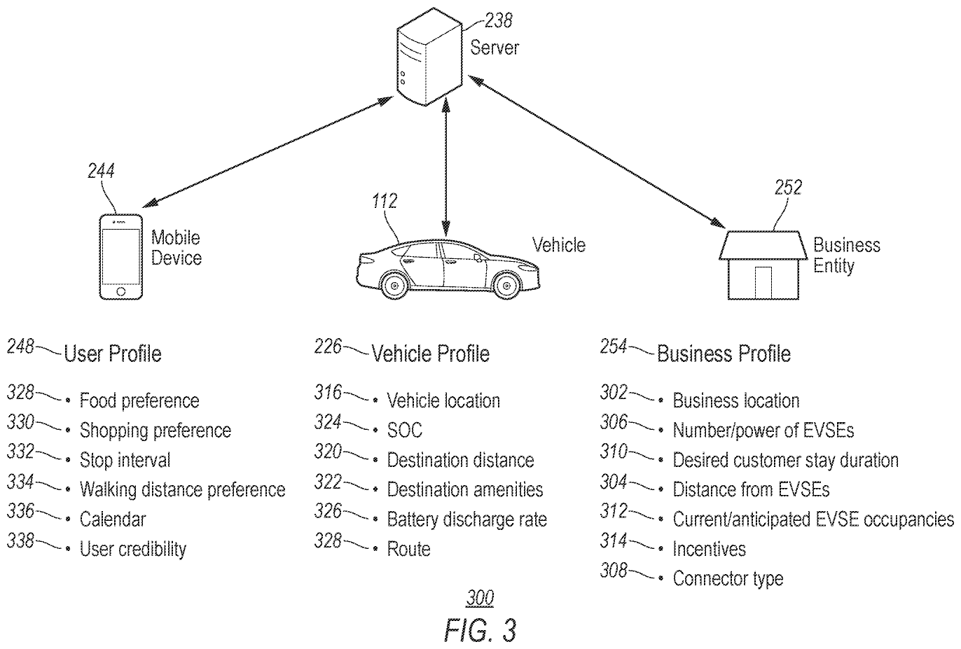

The server 238 may be further in communication with one or more business entities 252 associated with EVSEs 136. Each business entity may communicate a business profile 254 with the server 238 such that the server 238 may coordinate the charging for the one or more vehicle 112 by matching charging needs of the vehicles 112 and the preferences of the user with the capabilities of the business entities. Referring to FIG. 3, a diagram of the vehicle charging coordinating system 300 is illustrated. With continuing reference to FIGS. 1 and 2, the server 238 may be configured to communicate with various entities to perform the coordination and matching. It is noted that the term business entity used in the present disclosure may refer to any entity engaged in private or public businesses involving any industry such as restaurants, shops, gyms, cinemas or the like. Each of the business entities may be directly or indirectly involved in providing charging facilities to the electric vehicles. In other words, while some business entities may have chargers/EVSEs 136 installed on the premises and directly involved in the management and operations of the equipment, others business entities may be indirectly associated with chargers/EVSEs 136 located nearby and may not have controls over the equipment. Each business entity 252 may be associated with the business profile 254 including various entries. As a few non-limiting examples, the business entry 254 may include a business location entry 302 indicative of a location of the business and a distance to the EVSEs entry 304 indicative of a distance between the business location and the EVSEs location. As discussed above, the EVSEs 136 may be off-site the business and there may be a short distance therebetween (e.g. a few hundred meters). The business profile 254 may further include specifications of the EVSEs 136 such as a number/power of EVSEs entry 306 indicative of the number of the associated EVSEs 136 as well as the charger power supported by the EVSEs 136. The business profile 254 may further include a connector type entry 308 indicative of the type of connector supported by the EVSE 136. Different EVSEs 136 may support different types of connections to the vehicle. As a few non-limiting examples, the connector types may include Port J1772, SAE combo CCS, CHAdeMO types connectors, and/or wireless charging specifications. The business profile 254 may further include a desired customer stay duration entry 310 indicative of a desired time duration for customers to stay at the business. As discussed above, the business entities 252 may involve a variety types of businesses located at different places. For instance, a convenient store type business may desire the customers to stay for a short period of time (e.g. 10-15 minutes), whereas a casual dining type business may desire the customers to stay for a longer period of time (e.g. 1-2 hours). The desired customer stay duration may be further affected by the location of the business. In general, businesses located in high traffic areas (e.g. in the city, or near the highway) may have a shorter desired customer stay duration than businesses located in low traffic areas (e.g. in the countryside, less populated areas). The business profile 254 may further include a current/anticipated EVSE occupancies entry 312 indicative of a current and/or anticipated occupancies for the EVSEs. The business profile 254 may further include an incentive entry 314 indicative of incentives the business is willing to provide to each potential customer to stop by and use the businesses. For instance, a restaurant business entity 252 may offer potential customers a discount as an incentive to encourage the potential customers to select the associated EVSEs 136 and stop by for patronage based on time of the day and traffic flow. In addition, the same business entity 252 may offer different incentives to different customers based on their anticipated time for patronage. Continuing with the above restaurant example, the restaurant entity 252 may offer a greater incentive for a potential customer anticipated to stop by for a longer time based on the amount of charge as compared with a smaller incentive for another potential customer anticipated to stop by for a shorter time.

The server 238 may be further configured to receive the vehicle profile 266 from one or more vehicles 112. The vehicle profile 226 may include a vehicle location entry 316 indicative of the current location of the vehicle 112. The vehicle profile 226 may further include a route entry 318 indicative of a planned vehicle route and a destination distance entry 320 indicative of a distance from the current location to a navigation destination planned by the navigation controller 222. The vehicle profile 226 may further include a destination amenities entry 322 indicative of an availability of charging amenities (e.g. EVSE 136) at the planned destination of the vehicle 112. The availability of charging amenities may affect the desired charging time calculated by the server 238. For instance, if vehicle charging is available at the vehicle destination, the vehicle 112 may only need sufficient charge to reach the destination where the full battery charging may be performed. In this case, the vehicle 112 may only need to stop at an EVSE 136 for a short period of time. In contrast, if the vehicle charging is unavailable at the currently planned destination, the vehicle 112 may need an amount of charge sufficient to cover the next trip after the current destination until reaching the next available charging amenity. The vehicle profile 226 may further include a SOC entry 324 indicative of a current SOC of the traction battery 124 and a battery discharge rate entry 326 indicative of battery discharging rate based on usage.

The server 238 may be further configured to receive a user profile 248 from one or more mobile devices 244 of a vehicle user associated with the vehicle 112. The user profile 248 may include various entries indicative of a user preference to allow the server 238 to provide better match results to accommodate the user's needs. As a few non-limiting examples, the user profile 248 may include a food preference entry 328 and a shopping preference entry 330 indicative of food and shopping preferences of the user respectively. The user profile 248 may further include a stop interval entry 332 indicative of a driving stop interval preference of the user. The stop interval entry 332 may be recorded and presented in the form of a time interval to reflect a typical duration of driving time from the driver starting to drive until the driver stops to take a break and/or refuel the vehicle 112. The stop interval entry 332 may further indicate the duration of time at each stop. Alternatively, the stop interval entry 332 may be in the form of a distance. Some drivers may prefer a long driving interval with fewer longer stops (e.g. driving for a few hours for hundreds of miles and stopping for 1 hour) whereas others may prefer shorter driving intervals with more frequent shorter stops (e.g. driving for 1 hour for less than 100 miles and stopping for 15 minutes each time). The user profile 248 may further include a user walking distance preference entry 334 indicative of the walking distance preference of the user after parking the vehicle at the EVSE 136 for charging. Some users may prefer to stay within the vicinity of the EVSE 136 while waiting for the charging to complete (e.g. due to physical conditions and/or age of the user) while other users may not mind to walk a longer distance to reach other facilities. The server 238 may match the vehicle 112 with the business entity 252 by comparing the user walking distance preference entry 334 of the user with the distance from the EVSE entry 304. For instance, responsive to determining the business distance to the EVSE is within the user walking distance preference, the server 238 may list the business as a candidate to present to the user. The user profile 248 may further include user calendar entry 336 configured to access the calendar of the user such that the server 238 may access the location and time of past and future events of the user to plan the driving and charging. The user profile 248 may further include a user credibility entry 338 indicative of a record of the users to keep their appointments with the business entities 252. The user credibility entry 338 may be in the form of a score that increases if the user visits the entity selected by the user, and decreases if the user selects but fails to visit the selected entity.

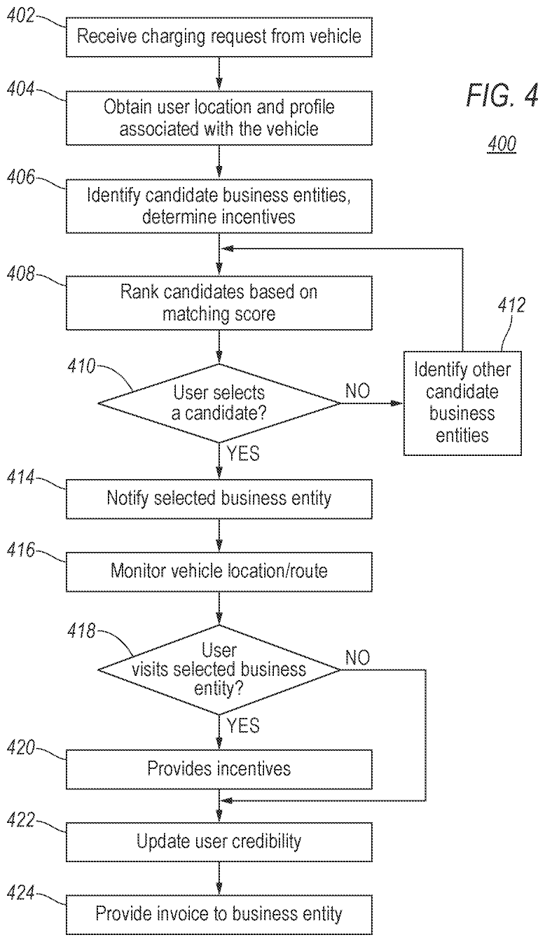

Referring to FIG. 4, an example flow diagram for a process 400 for coordinating vehicle charging is illustrated. With continuing reference to FIGS. 1-3, the process 400 may be individually or collectively implemented via various components of the charging coordinating system. The following description will be made with reference to the server 238 for simplicity purposes. At operation 402, the server 238 receives a charging request from the vehicle 112. The charging request may include an amount for charge requested and a geofence for charging locations determined by the vehicle 112. By sending the charging request to the server 238, the vehicle 112 may grant the server 238 access to the vehicle profile 112 stored in the vehicle 112 to allow the server 238 to better coordinate the charging process of the vehicle 112. At operation 404, responsive to receiving the charging request, the server 238 identifies and obtains a user profile associated with the vehicle 112 sending the request. As an example, the server 238 may request and obtain the user profile 244 from the mobile device 244 associated with the vehicle 112. To increase the accuracy of the coordination, the server 238 may be further configured to verify if it is the user using vehicle 112 by obtaining the location of the mobile device 244. Responsive to finding the user location from the mobile device 244 matches the vehicle location 112, the server 238 may proceed to obtain the user profile 244. Otherwise, if the user and vehicle locations do not match indicating someone else than the user is using the vehicle, the server 238 may proceed without using the user profile 248. Alternatively, in case that the user profile 248 is already stored in the cloud, the server 238 may directly access the user profile 248 without communicating with the mobile device 244. At operation 406, the server 238 identifies one or more business entities 252 using the location and charging amount of the charging request. The server 238 may further identify and filter the candidate business entities 252 using the user profile 248 previously obtained. The server 238 determines the incentives offered by each candidate business entity according to the anticipated duration of stay and time of the day. The server 238 may anticipate the duration of stay using the amount of charge requests and the charging power of the EVSEs 136 associated with the business and estimate the time of arrival using the distance between the vehicle location and the business entity 252. The server 238 may further identify and filter the candidate businesses for the charging request by matching the user profile 248 and the vehicle profile 226 with the business profile 252. The business profile 252 may be stored in the cloud and accessible by the server 238. A matching score may be calculated and assigned to each candidate business entity to reflect a degree of matching between the candidate and the current charging request.

At operation 408, the server 238 outputs the candidate business entities 252 in an order ranked by the matching score calculated and waits for a user input to select one of the candidates from the list. If none of the candidate business entities currently presented is satisfactory to the user, the process proceeds to operation 412 and the server 238 removes the current candidates from the list and re-identifies new candidates and calculates the matching score for each new candidate. Otherwise, responsive to the user selecting one of the candidate business entities from the list (e.g. via the HMI), the process proceeds to operation 414 and the server 238 notifies the user selection to the selected business entity. Alternatively, the user may visit one of the candidate businesses without sending a confirmation to the server 238. That is to say, responsive to seeing the candidate and the incentive offers, the user may navigate to the location unconfirmed to the business. In this case, the user may be provided with a different set of incentives than a confirmed planned charge event confirmed with the server 238. At operation 416, the server 238 monitors the vehicle location and route, and updates the estimated time of arrival to the business. At operation 418, if the user visits the selected business entity 252 as scheduled (e.g. based on the location of the mobile device 244), the process proceeds to operation 420 and the server 238 provides the incentives offered by the business entity 252 to the user. The process proceeds to operation 422 to update the user credibility entry 338 of the user profile to reflect the user's timely visit to the business as scheduled. If the user fails to visit the business, the process directly proceeds from operation 418 to operation 422 such that the user's failure to visit the selected business is reflected in the updated user credibility score 338. At operation 424, the server 238 sends an invoice to the selected business entity 252 for the service rendered to facilitating the match.

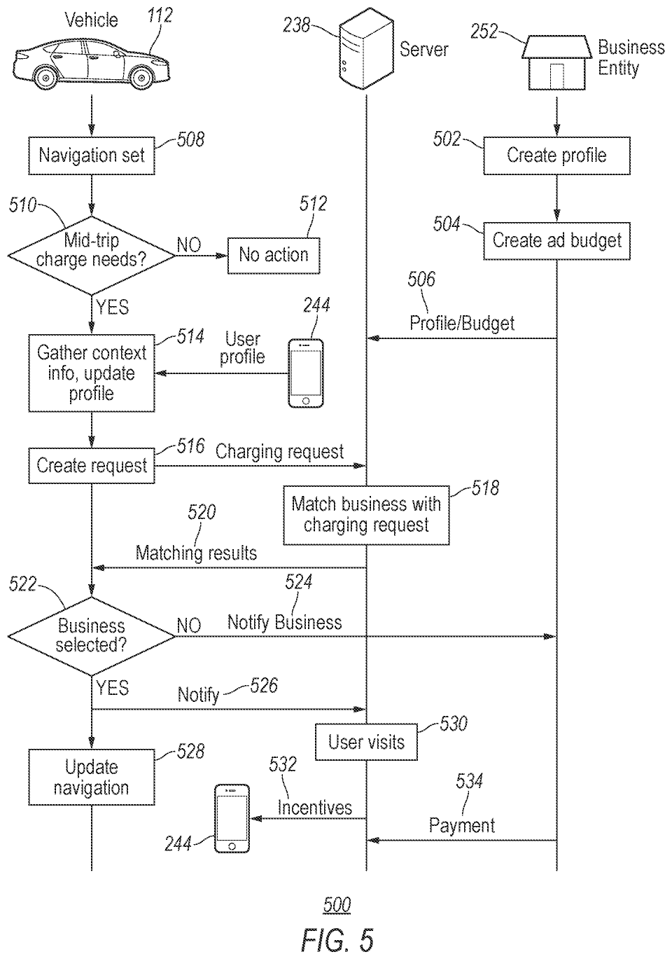

Referring to FIG. 5, an example flow diagram 500 of the vehicle charging coordinating system is illustrated. With continuing reference to FIGS. 1-4, at operation 502, the business entity 252 creates the business profile 254 reflecting the condition of the business as discussed with reference to FIG. 3. At operation 504, the business entity 252 creates/allocates an advertisement budget indicative of incentives the business would like to offer to potential customers using the vehicle charging system. A total incentive budget may be allocated for a period of time. Additionally, the budget may be detailed into specific incentives allocated to each potential customer based on the time of the day and anticipated duration to stop. At operation 506, the business entity 252 sends the business profile 254 and advertising budget to the server 238. On the vehicle side, responsive to a navigation destination set at operation 508, the computing platform 150 verifies if the current SOC of the traction battery 124 is sufficient to allow the vehicle 112 to reach the destination. In other words, at operation 510, the computing platform 150 determines if a mid-trip charge is needed while the vehicle 112 is on the route to the navigation destination. If the answer is a no, the process proceeds to operation 512 and the vehicle 112 takes no further actions. Otherwise, if the answer is a yes, the process proceeds to operation 514 and the computing platform 150 gathers context information and updates the vehicle profile 226 to prepare for the charging planning. The context information may include various information reflecting a vehicle context received from various sources. For instance, the context information may include weather information, traffic data, vehicle occupancy or the like. Additionally, the computing platform 150 may further obtains the user profile 248 from the mobile device associated with the vehicle 112. At operation 516, the computing platform 150 creates the charging request using the information received and sends the request to the server 238 to perform the match making.

At operation 518, responsive to receiving the charging request from the vehicle 112, the server 238 performs the charging coordination by matching business entities with the vehicle 112. In the present example, the business 252 qualifies the vehicle charging requests and the server 238 sends the information of the business entity 252 to the vehicle 112 as one candidate of the matching results at operation 520. As discussed above, each candidate entity may offer incentives to the potential customers. In the present example, the server 238 may send the incentive offered by the business entity 252 to the vehicle 112 alone with the matching results. The computing platform 150 may presents the matching results to the user in various manners. As an example, the computing platform 150 may present the one or more candidates via the display 214 and asks the user to make an input to select one from the candidates. If the business entity 252 is not selected by the user, the process proceeds from operation 522 to operation 524 to notify the business about the user selection via the server 238. Otherwise, if the user selects the business entity 252, the vehicle notifies the server 238 and notifies the business and/or place with a reservation with the business entity 252 at an estimated time of arrival at operation 526. At operation 528, the computing platform updates the navigation setting to add the business location as a stop of the vehicle navigation. Alternatively, the computing platform 150 may add the location of EVSE 136 associated with the business entity 252 to the navigation controller of the vehicle 222 such that the user may directly drive to the EVSE 136 to start to charge the vehicle first. In case that there is a distance between the EVSE 136 and the business entity 252, the server 238 may provide both the locations to the vehicle 112. The vehicle 112 may in turn set the EVSE location as the vehicle navigation destination, and send the business location to the mobile device 244 to help the user get to the business entity 252 after getting off the vehicle. Additionally, the vehicle 112 may drive to the EVSE 136 or the business entity 252 in an autonomous manner using the ADC 242. At operation 530, responsive to detecting the user has arrived at the business entity 252 as scheduled (e.g. via the location of the mobile device 224), the server 238 provides the incentive to the user. At operation 534, the business makes a payment to the server 238 for the match making service rendered.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle scheduling system comprising:
a server programmed to,
responsive to receiving a charge request for a vehicle, generate output identifying (i) a list of business entities within a predefined maximum distance of a target charging station that are ranked according to a match with a user profile associated with the vehicle and (ii) an incentive offer from at least one of the business entities, and
responsive to receiving input selecting one of the business entities, place a reservation with the one of the business entities according to an estimated time of arrival of the vehicle at the one of the business entities.

2. The vehicle scheduling system of claim 1, wherein the user profile defines the predefined maximum distance.

3. The vehicle scheduling system of claim 1, wherein the server is further programmed to, responsive to verifying a user associated with the user profile visits the one of the business entities, increase a value of a user credibility parameter of the user profile.

4. The vehicle scheduling system of claim 1, wherein the charge request includes an amount of charge requested by the vehicle.

5. The vehicle scheduling system of claim 1, wherein the charge request includes a desired charging power of the charging station.

6. The vehicle scheduling system of claim 1, wherein each of the business entities further has a desired customer stay duration at least equal to an anticipated charging period at the target charging station.

7. The vehicle scheduling system of claim 1, wherein the server is further programmed to place a charger reservation with a charging station associated with the one of the business entities, responsive to verifying a user associated with the user profile does not visit the one of the charging station as reserved, decrease a value of a user credibility parameter of the user profile

8. A server comprising:
a processor programmed to,
responsive to receiving a charging request for a vehicle, identify a plurality of candidate business entities associated with one or more chargers, obtain a business profile associated with each of the business entities and a user profile of a user associated with the vehicle to match with the business profiles, and assign a score to each of the business entities based on the match, and
responsive to the user selecting one of the business entities, calculate an estimated time of arrival for the vehicle to arrive at the one of the business entities, and set the one of the business entities as a navigation destination.

9. The server of claim 8, wherein the processor is further programmed to, responsive to a location of mobile device matching a location of the vehicle, use the user profile to match with the business profiles.

10. The server of claim 8, wherein the processor is further programmed to, responsive to detecting a location of a mobile device being within a geofenced region of the one of the business entities, provide an incentive from the one of the business entities to the mobile device.

11. The server of claim 8, wherein the user profile includes a user walking distance and the business profiles include a business to charger distance, and wherein the processor is further programmed to, responsive to the user walking distance being within the business to charger distance of a first of the business entities, identify the first of the business entities as one of the candidate business entities, and responsive to the user walking distance being greater than the business to charger distance of a second of the business entities, disqualify the second of the business entities from the candidate business entities.

12. The server of claim 8, wherein the charging request includes an anticipated charging period, and the business profiles include a desired customer stay duration, and wherein the processor is further programmed to, responsive to a difference between the anticipated charging period and the desired customer stay duration of a first of the business entities being within a predefined threshold, identify the first of the business entities as one of the candidate business entities.

13. The server of claim 8, wherein the user profile includes a user credibility parameter, and wherein the processor is further programmed to, place a charger reservation with charger associated with the one of the business entities, responsive to verifying vehicle charges at the charger as reserved, increase a value of the user credibility parameter.

14. The server of claim 13, wherein the processor is further programmed to, responsive to verifying vehicle does not charge at the charger as reserved, decrease a value of the user credibility parameter.

15. The server of claim 8, wherein the charge request includes a current state-of-charge (SOC) of the vehicle and a target SOC of the vehicle.

16. The server of claim 15, wherein the charge request includes a desired charging power of the charging station.

17. A vehicle scheduling system comprising:
a server programmed to,
responsive to receiving a charge request for a vehicle from a mobile device associated with the vehicle, the charge request including a desired charging duration, generate output identifying a plurality of target charging stations and a list of business entities associated with the target charging stations that matches the desired charging duration, and
responsive to receiving input selecting one of the business entities, set one of the charging station associated with the one of the business entities as a vehicle navigation destination.

18. The vehicle scheduling system of claim 17, wherein the server is further programmed to include a non-matching entity in the list with an incentive offered by the non-matching entity, wherein the non-matching entity is associated with one of the target charging stations but does not match the desired charging duration.

19. The vehicle scheduling system of claim 17, wherein the server is further programmed to responsive to receiving input selecting one of the business entities, send an address of the one of the business entities to the mobile device.

20. The vehicle scheduling system of claim 17, wherein the charge request includes a desired amount of charge, and a desired charging power of the charging station.
